(19) United States
(12) Patent Application Publication
(10) Pub. No.: US 2021/0094117 A1
(43) Pub. Date: Apr. 1, 2021

(54) METHOD FOR THE MECHANICAL THERMAL CUTTING OF A WORKPIECE USING A PLASMA CUTTING TORCH

(71) Applicant: Messer Cutting Systems GmbH, Gross-Umstadt (DE)

(72) Inventors: Ingo GÖLLER, Groß-Zimmern (DE); Bernd ROHN, Maintal (DE)

(73) Assignee: Messer Cutting Systems GmbH, Gross-Umstadt (DE)

(21) Appl. No.: 16/982,120

(22) PCT Filed: Mar. 21, 2019
(86) PCT No.: PCT/EP2019/057059

§ 371 Date: Sep. 18, 2020

(30) Foreign Application Priority Data
Mar. 21, 2018 (DE) 10 2018 106 639.2

(51) Int. Cl. B23K 10/00

(52) U.S. Cl. CPC B23K 10/00; B23K 2103/05

(57) ABSTRACT

Known methods for the mechanical thermal cutting of a workpiece using a plasma cutting torch include the steps of: a) igniting a plasma jet, b) producing a lead-in cut into a metallic, strip- or plate-type semi-finished product using the plasma jet and c) cutting a contour into the semi-finished product by guiding the plasma jet along a predefined contour line at a cutting speed in a cutting direction. Provided herein is such a method which further includes, after cutting the contour according to step c), guiding the plasma jet in the opposite direction to the cutting direction along at least a portion of the cut contour at a return speed, in order to achieve a high cut quality and high dimensional precision.

### TECHNICAL FIELD

The present invention relates to a method for the mechanical thermal cutting of a workpiece using a plasma cutting torch, comprising the method steps of:
a) igniting a plasma jet,
b) producing a lead-in cut in a metallic, strip- or plate-type semi-finished product using the plasma jet,
c) cutting a contour into the semi-finished product by guiding the plasma jet along a predefined contour line at a cutting speed in a cutting direction.

The method according to the invention is a mechanical thermal contour-cutting method. It can be used in particular for the automatic cutting of a contour into a metallic semi-finished product, preferably for cutting a contour into a semi-finished product made of high-alloy steel (stainless steel) or aluminium.

The term “contour” within the meaning of the invention is understood to be a self-contained outline. The contour can be in the form of an inner contour or an outer contour. An outer contour describes an outline of the external geometric shape of the cut-out workpiece (also referred to below as the “component”). An inner contour is a geometric shape in the “interior” of a workpiece, which is delimited by workpiece material and is accessible on at least one side for a machining tool, e.g. the outline of an internal bore.

### BACKGROUND ART

For the thermal cutting of workpieces made of metal, fusion cutting methods are often employed. In these methods, such a high energy input takes place into the semi-finished product that the semi-finished product is completely melted in the cut region and is thus cut. The energy needed for this is provided by, for example, a plasma jet. A plasma jet is an ionised gas jet, which is produced using an arc. In metal machining, and particularly in the processing of sheet metals, it is usual to work with a transferred arc, i.e. the semi-finished product forms the anode and the electrode of the torch forms the cathode for producing the arc. The highest possible energy input into the semi-finished product to be cut is made possible if the plasma jet is concentrated and guided into the region of the future kerf by a nozzle.

When contours with complex geometries are produced, it is often difficult to produce them with high dimensional precision. The semi-finished product into which a workpiece contour is to be cut can be differentiated in principle into wanted and unwanted material. “Wanted material” refers to the part of the semi-finished product that eventually forms the cut workpiece (component). The term “unwanted material” covers the remaining part of the semi-finished product, i.e. the part that is scrapped after cutting, including the material of the kerf. To improve the dimensional precision and quality of a cut, it is known to place the starting point of the cut in the unwanted material and firstly to cut a lead-in cut (also referred to below as a “lead-in path”) into the unwanted material, immediately followed by the actual contour cut. As a result, in particular the instability of the plasma jet geometry and the resulting imprecisions in the cut that can be observed shortly after the ignition of the plasma jet and the start of the cutting operation occur predominantly while cutting the lead-in cut, so that the contour cut is started only when the cutting behaviour of the plasma jet has stabilised.

A plasma contour-cutting method of the above-mentioned type is known e.g. from WO 2015/121745 A1. It is proposed there that, for cutting a hole, the starting point of the cutting operation should be placed in the unwanted material, from where a lead-in cut should be made that leads into the actual contour cut. At the end of the contour cut, a lead-out cut (also referred to below as a “lead-out path”) is cut into the unwanted material.

The plasma jet drives molten semi-finished product material out of the kerf. If it is not driven out completely, the cut quality can be impaired by deposition of semi-finished product material in the region of the kerf on the underside.

Furthermore, plasma cutting methods routinely produce kerfs with a V-shaped cross-section. The reason for this is the sloping geometry of the plasma jet, as a result of which the semi-finished product is melted and initially cut in a sloping manner. The cut surfaces obtained when cutting workpieces with a plasma jet therefore slope towards each other slightly relative to the workpiece surface. The cut surfaces form a cut angle α<90° with the material surface. With intricate contours in particular, tapering cut surfaces can negatively affect the cut contour diameter and thus the contour accuracy.

Furthermore, when cutting high-alloy steels (stainless steel) for example, the problem is often observed that the arc “jumps” at the end of the contour in the region where the lead-in and lead-out paths cross, so that micro-bridges can remain. An example of an incorrect cut of this type is shown in FIG. 4.

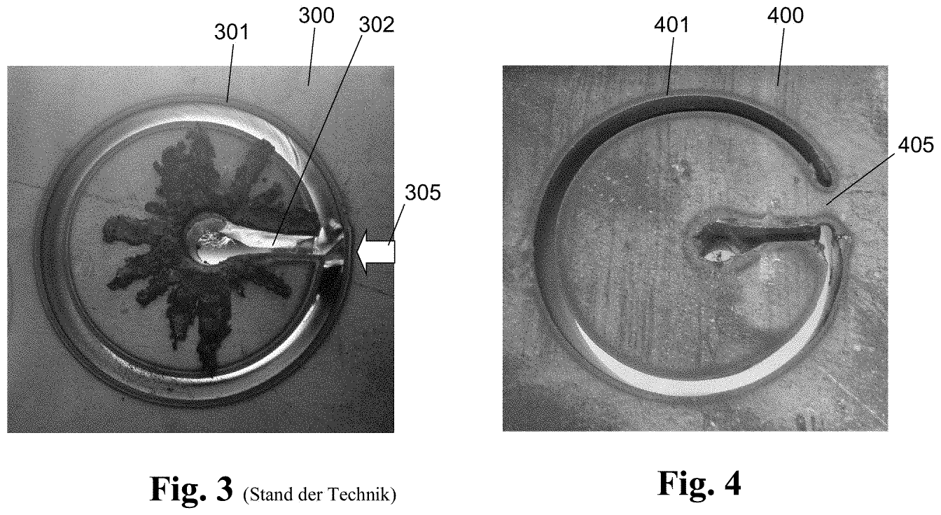

Moreover, cut surface damage or burr formation can occur in the region of the cut surfaces. An example thereof is shown in FIG. 3, in which a cut workpiece with cut surface damage is shown, as is often observed in the lead-in and lead-out regions.

### TECHNICAL PROBLEM

The invention is therefore based on the object of specifying a method for the mechanical thermal cutting of a workpiece using a plasma cutting torch, which allows high cut quality and high dimensional precision to be achieved even with intricate contours and in particular with intricate inner contours.

### GENERAL DESCRIPTION OF THE INVENTION

This object is achieved according to the invention, starting from a method of the type mentioned above, in that after the contour has been cut according to method step c), the plasma jet is guided in the opposite direction to the cutting direction along at least a portion of the cut contour at a return speed.

The method according to the invention is based on the finding that a significant part of the cut damage that occurs can be attributed to the fact that the contour cut takes place in a single cutting direction.

One of the reasons for this is that the plasma jet lags behind the cutting movement in plasma cutting; this phenomenon is also known as plasma lag. Plasma lag affects the quality of the cut surface, the cut angle and the energy input into the semi-finished product. The actual cutting operation takes place in the region of the plasma lag. If, for example, the cutting speed rises, the plasma lag also increases and therefore the cut angle α at which the workpiece is cut also decreases. This contributes to a decline in contour accuracy.

The extent of the plasma lag here depends on various parameters, such as the cutting speed, the current, the type of semi-finished product or the semi-finished product thickness; in particular, it has a greater effect on cut quality with small geometric contour shapes than on a straight portion of a contour or when cutting larger contour shapes.

According to the invention, therefore, it is provided to improve the cut quality by reversing the cutting direction after a first cut has been made and guiding the plasma jet back along at least a portion of the cut contour. When the cutting direction is reversed, the position of the plasma lag changes relative to the workpiece since this position is also reversed when the plasma jet is guided back.

Because the change in direction of the plasma jet is provided only after the contour has been cut completely, it is no longer necessary to cut any fresh contour, which can lead to the cut damage explained above, when guiding the plasma jet back in the opposite direction to the cutting direction. Furthermore, all the energy of the plasma jet is available for reworking the contour that has already been produced. In this case, where work is being carried out with a transferred arc, the plasma jet is in contact with the cut surfaces, in particular the protrusions thereof, e.g. with the burrs, tabs or uncut contour residues formed during the contour cut. The available energy of the plasma jet can therefore be utilised for removing remaining bridges, minimising burr and tab formation and straightening the existing cut surfaces and freeing them from uncut contour residues. This allows effective contour reworking to take place immediately after the cutting operation.

The cutting speed when cutting the lead-in or lead-out path necessarily varies. When cutting the contour, on the other hand, it has proved expedient to set a cutting speed that is, as far as possible, constant. Preferably the cutting speed is in a range of 1 m/min to 3 m/min; in particular in the range of 100 to 2500 mm/min when cutting stainless steel plates with thicknesses of 5 to 100 mm, in the range of 400 to 3000 mm/min when cutting aluminium plates with thicknesses of 5 to 100 mm and in the range of 700 to 1600 mm/min when cutting structural steel plates with thicknesses of 30 to 50 mm. This allows a cut that is as uniform as possible to be achieved, together with a homogeneous cutting pattern.

Likewise, it has proved expedient if the plasma jet is guided in the opposite direction to the cutting direction at a constant return speed.

The return speed has a significant effect on the amount of energy introduced into cut surfaces. A low return speed is associated with a high energy input into the cut surfaces, and vice versa, a high return speed leads to a lower energy input into the cut surfaces. If the amount of energy introduced into the cut surfaces is too high, the cut surface is exposed to high thermal stresses, which can be associated with changes to the material properties of the semi-finished product. If the amount of energy introduced into the cut surfaces is too low, any remaining bridges, tabs or bevels are not adequately removed. It has therefore proved expedient on the one hand if the return speed is in the range of 150% to 400% of the cutting speed. Preferably, the return speed is in the range of 2.5 m/min to 20 m/min. Alternatively, a return speed of less than 150% and in particular in the range of 30% to 100% of the cutting speed is preferred in the contour cutting of thick semi-finished products (with thicknesses of more than 50% of the aforementioned upper limits of the respective plate thicknesses for stainless steel, structural steel and aluminium). The return speed may be in the range of e.g. 0.3 to 3 m/min, as appropriate. The return speed can also be increased continuously, starting from this low speed and rising to 400% of the cutting speed.

When cutting large contours in particular, it does not seem useful to guide the plasma jet back completely over the entire contour. This would require a large amount of energy and time. It has in fact been shown that cutting damage frequently occurs in the lead-in and/or lead-out region of the contour. One reason for this could be that the lead-in and lead-out regions often overlap in a certain region, and so this overlap region is exposed to higher thermal stresses. The amount of energy introduced into this region is also generally higher, compared to the other portions of the contour. A reworking of the contour cut in at least the overlap region of the lead-in and lead-out paths is therefore particularly advantageous.

When the plasma jet is guided in the opposite direction to the cutting direction, a large amount of heat can be generated, which can act on the previously produced contour cut surfaces. This enables good contour machining to be achieved. Any remaining bridges, tabs or bevels can be cut when the plasma jet is guided in the opposite direction. Moreover, the heat input into the existing cut surfaces also contributes to straightening them and to compensating for the cutting angle.

On the other hand, for small contours it may be entirely appropriate to guide the plasma jet along the entire contour in the opposite direction to the cutting direction. In a preferred embodiment of the method according to the invention, it is therefore provided that, after cutting the contour according to method step c), the plasma jet is guided in the opposite direction to the cutting direction along the entire cut contour. Small contours have e.g. a diameter corresponding to the thickness of the semi-finished product to be cut (1:1). For greater thicknesses (more than 50% of the above-mentioned upper limits of the respective plate thicknesses for stainless steel, structural steel and aluminium), contours with even smaller diameters than 1:1 can be achieved.

In particular for contours with a small peripheral length, deviations in the contour have a particularly marked impact. With the repeated guiding of the plasma jet in the opposite direction to the cutting direction, remaining bridges are effectively removed and bevels and burrs are straightened. By guiding the plasma jet in the opposite direction to the cutting direction along the entire cut contour, a contour with a particularly high cut quality is produced.

It has proved useful if the cutting of the lead-in cut takes place at a lead-in cut speed, with the lead-in cut speed being increased while cutting the lead-in cut until the cutting speed is reached.

The lead-in cut located in the unwanted material is intended to perform the function of bringing the plasma cutting torch up to the predefined cutting speed before it meets the contour line to enable a contour cut to be achieved that is as uniform as possible. The fact that the cutting torch and therefore the plasma jet can be accelerated to cutting speed while cutting the lead-in cut enables the actual contour cut to be started immediately after cutting the lead-in cut. This requires no further acceleration of the plasma cutting torch. This is important because the current cut speed affects the position of the plasma lag. Were it necessary to increase the cut speed up to cutting speed while cutting the contour, this would have to be compensated by complex measures, e.g. adjustments to the current.

Otherwise, a negative impact on cut quality would be likely. Moreover, the cutting process stabilises while cutting the lead-in cut, so that when the plasma jet transfers from the lead-in cut into the actual contour cut, a plasma jet that is as stable as possible is available for cutting the contour.

In a preferred variant of the method it is provided that, while the plasma jet is being guided in the opposite direction to the cutting direction along at least a portion of the cut contour, the return speed is reduced continuously.

The guiding of the plasma jet in the opposite direction to the cutting direction serves for reworking at least a portion of a contour that has already been cut. This portion of length will also be referred to below as the “back cut”. The return speed can correspond to the cutting speed or can differ therefrom; it can be substantially constant over the length of the back cut, but it is preferably reduced continuously or stepwise over at least a partial length of the back cut. By reducing the return speed, the lag of the plasma jet is reduced and so the intensity of reworking can be adapted to the reworked contour portion. Moreover, a low lag has the advantage that any remaining bridges or bevels on the cut surfaces can be straightened more easily.

In this context, it has proved advantageous to reduce the return speed to zero while the plasma jet is being guided in the opposite direction to the cutting direction. If the return speed is reduced to zero during reworking, there is no need for an additional lead-out path. When reducing the return speed, the plasma jet is preferably switched off as early as possible.

Preferably, the method according to the invention is used for cutting a contour into a semi-finished product made of steel, preferably stainless steel, or aluminium.

When cutting stainless steel in particular, but also when cutting other steels, a micro-bridge can remain on the workpiece. The method according to the invention contributes to eliminating any micro-bridges that have formed in that they are cut when the plasma jet is guided in the opposite direction to the cutting direction.

The method can advantageously be employed for cutting steels with a material thickness in the range of 5 mm to 100 mm if, after cutting the contour according to method step c) and before guiding the plasma jet in the opposite direction to the cutting direction, a further cut takes place in the cutting direction.

In the case of semi-finished products made of stainless steel or aluminium, the method can advantageously be employed in particular if, after cutting the contour according to method step c) and before guiding the plasma jet in the opposite direction to the cutting direction, a further cut takes place in the cutting direction. When structural steels, stainless steel or aluminium in particular are being cut, a micro-bridge can remain at the beginning or end of the contour. This effect occurs in particular when working with a transferred arc in which the semi-finished product forms the anode of the arc. It can happen in this case that the arc jumps between a region ahead of the micro-bridge and a region behind the micro-bridge, so that complete fusion is not achieved in the region of the micro-bridge. By cutting further in the cutting direction, the position of the arc is located behind any remaining micro-bridge for a certain period, so that this can be cut by the plasma lag. This reduces the occurrence of micro-bridges on the finished cut component.

Particularly good results in relation to reducing micro-bridge formation are achieved if the further cut takes place at a higher speed than the cutting speed during the contour cut. This contributes to enabling the plasma lag to be increased, thus effectively cutting the micro-bridge.

In a further preferred embodiment of the method according to the invention it is provided that, when cutting the contour according to method step c), the position of the plasma jet is shifted to the right or left in relation to the contour line, depending on the cutting direction.

A plasma jet has a certain spatial extension; generally, the plasma jet has a round cross-section in relation to the workpiece surface. As a result, the plasma jet cannot be guided directly along the eventual contour of the workpiece, since parts of the wanted material would otherwise be cut off by the plasma jet. Instead, the plasma jet generally has to be offset towards the unwanted material relative to the planned contour line by about half its cross-sectional extension. For an inner contour the unwanted material is inside the contour. When cutting an inner contour in a clockwise direction, therefore, the position of the plasma jet is shifted to the right in relation to the contour line; if the inner contour is cut in an anti-clockwise direction, the position of the plasma jet is shifted to the left in relation to the contour line. The same applies to cutting an outer contour. Here, the position of the plasma jet is shifted to the left when cutting the contour in a clockwise direction, viewed in the cutting direction. The cutting of an outer contour in an anti-clockwise direction takes place with a plasma jet shifted to the right in the cutting direction.

In this context it has proved expedient if, when guiding the plasma jet in the opposite direction to the cutting direction, the position of the plasma jet is shifted from the left to the right or from the right to the left, as appropriate, relative to the contour line.

Attention should be paid to the position of the plasma jet particularly when changing the cutting direction. To avoid the plasma jet's cutting into the wanted material, it is necessary to offset the plasma jet simultaneously when the direction is reversed, according to the contour line. It has proved expedient if the position of the plasma jet is changed automatically using an electronic control system when the direction is reversed.

### EXEMPLARY EMBODIMENT

The invention will be described in more detail below with the aid of exemplary embodiments and drawings. The figures show the following:

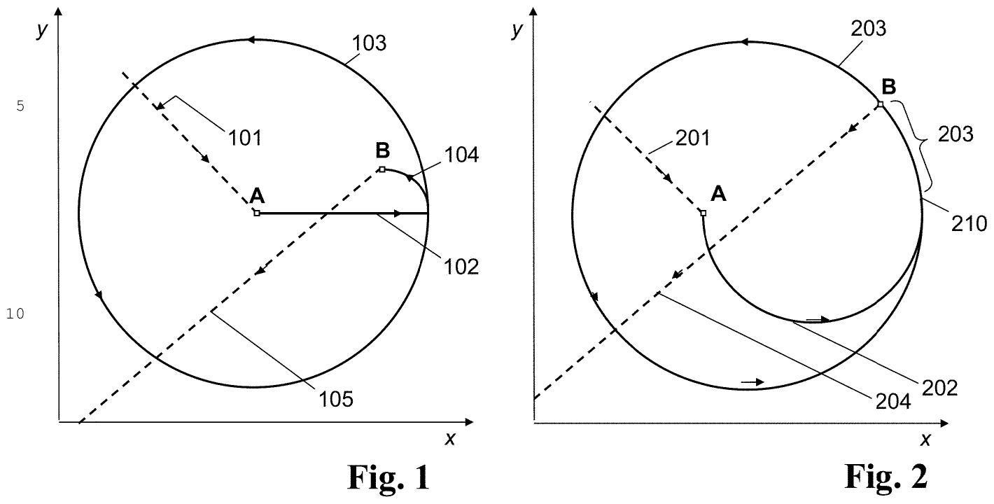

FIG. 1: an illustration of the position of a plasma cutting torch nozzle over a workpiece surface during a cutting operation with a perpendicular lead-in path,

FIG. 2: an illustration of the position of a plasma cutting torch nozzle over a workpiece surface during a cutting operation with a semi-circular lead-in path,

FIG. 3: a first stainless steel workpiece with an incompletely cut, circular inner contour, which was produced by a plasma cutting machine using a conventional cutting method,

FIG. 4: a second stainless steel workpiece with an incompletely cut, circular inner contour, which was produced by a plasma cutting machine using a conventional cutting method,

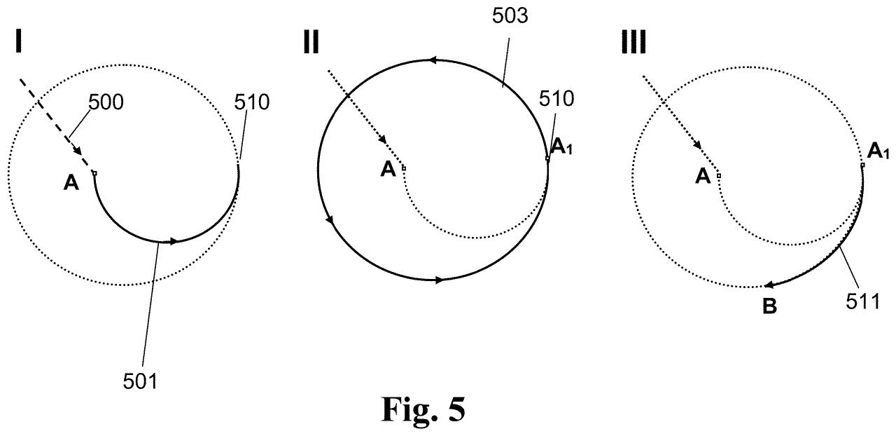

FIG. 5: a first variant of a cutting method according to the invention with the method steps of: cutting a lead-in path (I), cutting a predefined contour (II) and guiding the plasma jet along a portion of the cut contour (III).

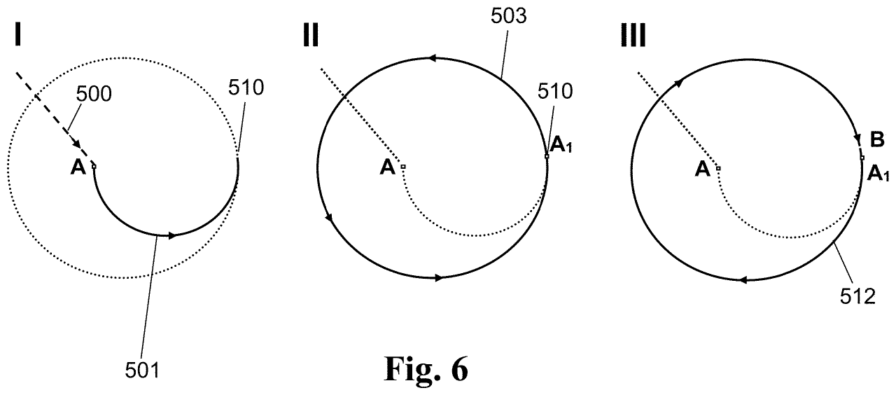

FIG. 6: a second variant of a cutting method according to the invention with the method steps of: cutting a lead-in path (I), cutting a predefined contour (II) and guiding the plasma jet along the entire cut contour (III).

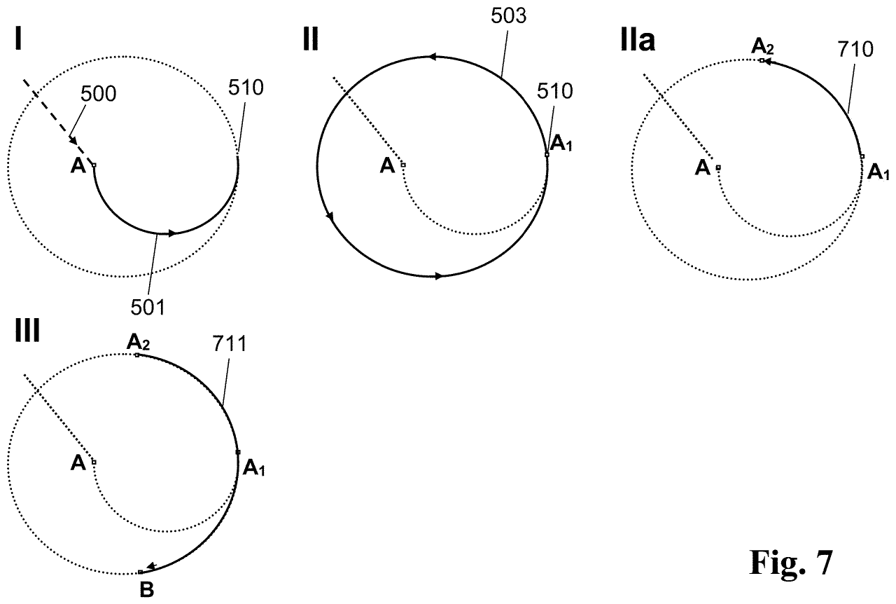

FIG. 7: a third variant of a cutting method according to the invention with the method steps of: cutting a lead-in path (I), cutting a predefined contour (II), a further cut in the cutting direction (IIa), guiding the plasma jet along a portion of the cut contour (III), and optionally cutting a lead-out path (IV),

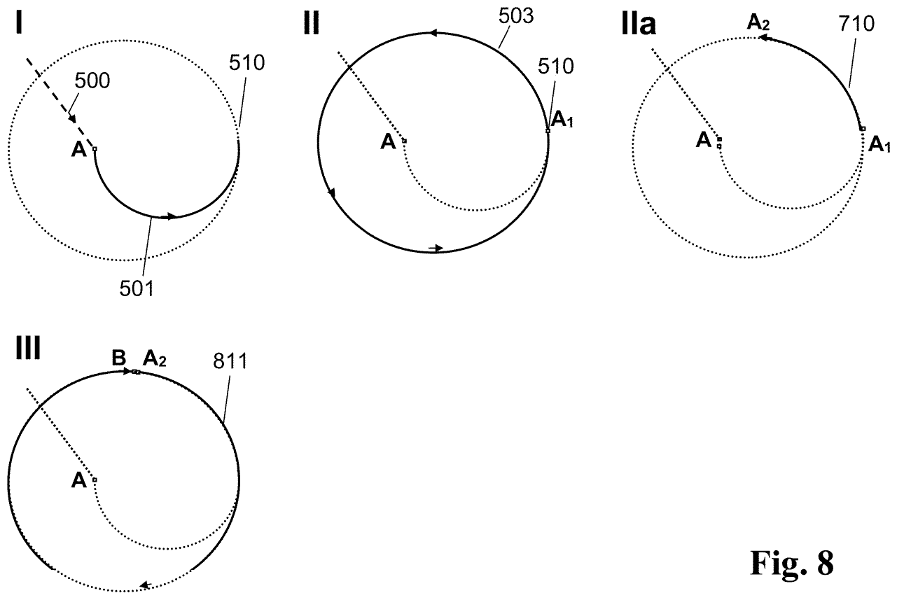

FIG. 8: a fourth variant of a cutting method according to the invention with the method steps of: cutting a lead-in path (I), cutting a predefined contour (II), a further cut in the cutting direction (IIa), guiding the plasma jet along the entire cut contour (III), and optionally cutting a lead-out path (IV),

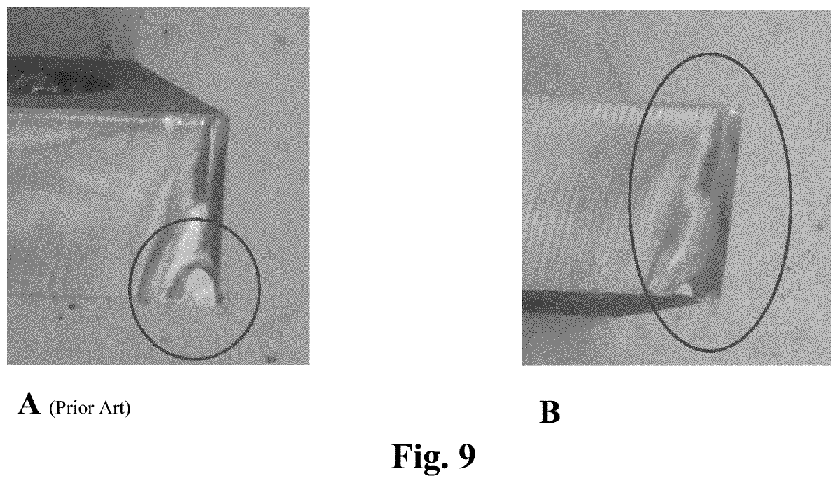

FIG. 9: a comparison of an outer contour (B) of a workpiece that was obtained using a cutting method according to the invention, and an outer contour (A) of a workpiece as obtained by a conventional cutting method, and

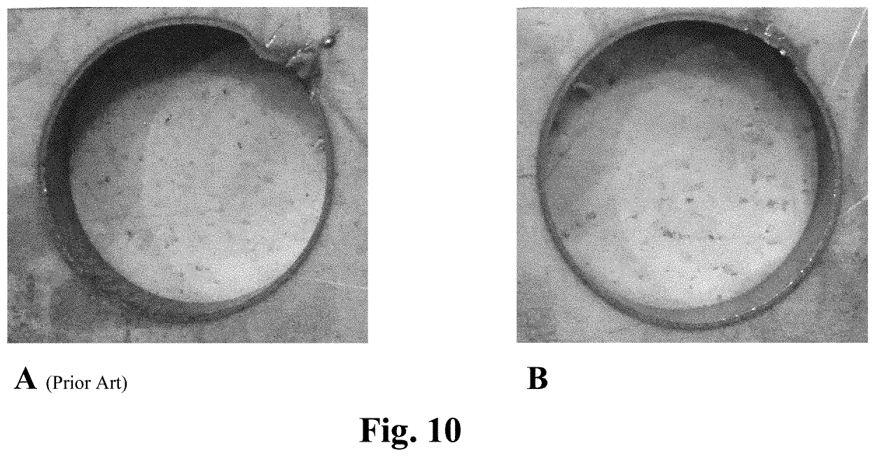

FIG. 10: a comparison of an inner contour (B) of a workpiece that was obtained using a cutting method according to the invention, and an inner contour A, as obtained by a conventional cutting method.

FIG. 1 shows the changes in position of a plasma cutting torch nozzle during a cutting operation relative to a workpiece surface, which is described by arrows x, y.

The plasma cutting torch, including nozzle, is mounted on a movable gantry and is movable relative to the workpiece surface. In the exemplary embodiment, the semi-finished product is a plate made of stainless steel with the following dimensions: length (L)=100 mm, width (B)=100 mm and height (H)=30 mm, into which a circular inner contour with a diameter of 38 mm is to be cut using the plasma cutting torch. The method for cutting the inner contour will be described in more detail below:

Before the inner contour is cut, the plasma cutting torch nozzle is first moved to a start position (A). The start position (A) is located in the unwanted material of the semi-finished product. While the plasma cutting torch nozzle is being positioned, the plasma cutting torch is not in operation. In FIG. 1, this method step is indicated by the broken line 101.

As soon as the plasma cutting torch nozzle has reached the start position (A), the plasma cutting torch is ignited. The plasma cutting torch nozzle is held in the start position A until it has pierced through the semi-finished product.

Once piercing has occurred, a lead-in cut (lead-in path) is firstly cut into the semi-finished product. To this end, the plasma cutting torch nozzle is moved in the direction of the arrow along the lead-in line 102 to a contour starting point while being accelerated from zero to a predefined cutting speed. The lead-in line 102 is selected such that it meets the eventual contour line 103 at an angle of 90°; it runs radially to the contour line 103.

From the contour starting point, the plasma cutting torch nozzle is guided at the predefined cutting speed of approx. 500 mm/min in an anti-clockwise direction on the predefined contour line 103, which is offset by approx. 3 mm to the left relative to the eventual inner contour of the workpiece. Such an offset of the contour line is necessary since the plasma jet produced by the plasma nozzle itself has a round cross-section with a mean diameter of approx. 6 mm. In this way, it is ensured that a hole is cut exactly with the predefined radius. The plasma cutting torch nozzle is guided in an anti-clockwise direction along the contour line 103 until it reaches the contour starting point again. Further steps can then be provided, e.g. guiding the plasma jet in the opposite direction to the contour line 103. To aid understanding and for reasons of clarity, these are not illustrated in FIG. 1. These method steps will be described below with the aid of FIGS. 5 to 8.

Finally, a lead-out path is cut into the unwanted material by guiding the plasma cutting torch nozzle along the lead-out line 104 until the end position (B) is reached. The plasma cutting torch is switched off during its travel to the end position B. As soon as the end position (B) has been reached, the plasma cutting torch nozzle is moved along the broken line 105 to a region such that it is no longer assigned to the workpiece surface.

FIG. 2 shows the sequence of an alternative cutting method. Here, in an x, y plot, the position of a plasma cutting torch nozzle over a workpiece surface during a cutting operation is illustrated. Compared to the cutting method of FIG. 1, in particular the shape of the lead-in path and the position of the lead-out path are modified in the cutting method according to FIG. 2.

Before the lead-in path is cut, the plasma cutting torch nozzle is brought along the line 201 to the start position (A) in the unwanted material. As soon as the plasma cutting torch nozzle has reached the start position (A), the plasma cutting torch is ignited. The plasma cutting torch nozzle is held in the start position (A) until it has pierced through the semi-finished product.

The lead-in path is then cut by guiding the plasma cutting torch along a semi-circular lead-in line 202 to a contour starting point 210 while accelerating it from zero to a predefined cutting speed. The position of the lead-in line 202 here is selected such that a change in direction of the plasma cutting torch nozzle at the contour starting point is not necessary; the lead-in line hits the contour line 203 at a tangent. This tangential meeting with the lead-in line 202 enables cut quality to be improved for circular inner contours in particular.

From the contour starting point 210, the plasma cutting torch nozzle is guided at the predefined cutting speed of 600 mm/min on the predefined contour line 203, which—as described for FIG. 1—is offset by 3 mm to the left relative to the eventual inner contour of the workpiece. The cutting direction runs anti-clockwise until the contour starting point 210 is reached again.

While the contour line is being cut, the cutting speed is kept constant. Once the contour starting point 210 has been reached again, a “further cut” 203a is provided in the cutting direction along the contour line 203 that has already been cut until a cut end position (B) is reached. During the further cut 203a, the speed is reduced down to zero at the end position (B).

Further steps can then be provided, e.g. guiding the plasma jet in the opposite direction to the contour line 203. To aid understanding, these are not illustrated in FIG. 2. These method steps will be described more precisely below with the aid of FIGS. 5 to 8.

The cutting of a lead-out path into the unwanted material is optionally possible (not illustrated). In the present exemplary embodiment, the plasma cutting torch is switched off at the end position (B) and the plasma cutting torch nozzle is moved along the broken line 204 to a region such that it is no longer assigned to the workpiece surface.

In conventional methods for cutting a contour with a plasma cutting torch, cut surface damage is often observed in the lead-in and/or lead-out region. Such cut surface damage is particularly undesirable when cutting small holes with a diameter of less than 20 mm, since cut surface damage to these holes has a particularly marked impact on the effective hole diameter. In FIGS. 3 and 4, examples of such cut surface damage are shown, as can often be observed particularly when cutting workpieces made of high-alloy steels (stainless steel).

FIG. 3 shows a workpiece 300 made of stainless steel that has undergone a conventional cutting method for producing a hole-type inner contour 301. The inner contour 301 is circular in form; the circle diameter is 36 mm. The thickness (height) of the workpiece 300 is 20 mm.

The cutting method comprised the method steps of: a) positioning the plasma cutting nozzle, starting from a starting position, at a position above the material of the inner contour, the so-called unwanted material, b) operating the plasma cutting torch, c) piercing the unwanted material, d) cutting a lead-in path 302 running perpendicular to the inner contour 301, e) cutting the circular contour 301, f) switching off the plasma cutting torch and g) moving the plasma cutting torch nozzle to the starting position.

Apart from the fact that the cut is not complete, FIG. 3 shows that cut surface damage can occur in particular in the region where the lead-in path 302 meets the contour 301 (see arrow 305). The smaller the diameter of the contour 301, the greater the impact of this cutting damage on the effective diameter of the contour 301.

FIG. 4 shows a workpiece 400 made of stainless steel, which has likewise undergone the cutting process explained with reference to FIG. 3. The inner contour 401 is circular in form; the circle diameter is 38 mm. The thickness (height) of the workpiece 300 is 20 mm.

When cutting the contour (method step e) according to FIG. 4, the arc has “jumped” at the end of the contour cut in the region where lead-in cut and lead-out cut cross, such that a micro-bridge 405 has remained. This phenomenon is often observed when cutting high-alloy steels and in particular when cutting stainless steel.

With the aid of FIGS. 5 to 8, four variants of the method according to the invention will be described in detail. To simplify the illustration of the method steps, each of the method variants is shown in a plurality of drawings (I, II, III or I, II, IIa, III), with the drawings representing different method stages in a time sequence. The current method steps of a method stage in each case are indicated by continuous, black lines. Method steps that have taken place previously and orientation lines are illustrated by broken lines. Where the same reference numerals are used in FIGS. 6, 7 and 8 as in FIG. 5, they denote method steps that are the same as or equivalent to those explained with reference to FIG. 5.

FIG. 5 shows a schematic diagram of the sequence of method steps of a cutting method that is used in particular for processing semi-finished product material thicknesses in a range of 5 mm to 100 mm.

Firstly, the plasma cutting torch nozzle is moved along the broken line 500 to the start position A. As soon as the plasma cutting torch nozzle has reached the start position A, the plasma cutting torch is ignited and held in the start position A until it has pierced through the semi-finished product. Finally, a lead-in path 501 is cut into the semi-finished product. FIG. 5-I shows a semi-circular lead-in path 501 as described above e.g. with reference to FIG. 2, which tangentially meets the contour line 503 to be cut. Naturally, the shape and course of the lead-in path 501 can, in principle, be selected at will. While the lead-in path is being cut, the plasma cutting torch nozzle is accelerated to cutting speed. At the contour starting point 510, the plasma jet is guided through the lead-in path 501 up to the contour starting point 510 in such a way that no change in direction is necessary.

Moreover, the plasma jet is already at cutting speed when it reaches the contour starting point 510, so that there is likewise no need for a change in speed.

FIG. 5-II shows the actual contour cut, which immediately follows the cutting of the lead-in path 501. The cutting of the lead-in path 501 ends when the contour starting point 510 is reached. Starting from there, the contour 503 is cut at cutting speed until the contour end point A1, which is identical with the contour starting point, is reached.

According to FIG. 5-III, the plasma cutting torch is guided in the opposite direction to the cutting direction along the portion 511 of the contour 503 to the end position B at the return speed. During this process, the return speed of the plasma cutting torch is reduced in steps down to zero, so that it is unnecessary to cut an additional lead-out path. By reducing the return speed and the associated deceleration of the plasma torch cutting machine, the lag of the plasma jet is reduced. Since part of the contour 503 was cut again in the opposite direction, any bridges remaining in the region of the counter-cut are cut and bevels are straightened.

FIG. 6 shows a variant of the cutting method described for FIG. 5, which can likewise be employed for processing semi-finished product material thicknesses in a range of 5 mm to 100 mm.

The illustrations in FIG. 6-I and in FIG. 6-II correspond to those of FIGS. 5-I and 5-II. Accordingly, reference is made to the description of the latter figures.

FIG. 6-III shows that, at the end of the contour cut 503, the plasma jet produced by the plasma cutting torch is guided in the opposite direction to the previous cutting direction along the portion 512 of the contour 503, the portion 512 here being in the form of a full circle, so that the complete contour is cut in the opposite direction. This method is particularly suitable for small circular contours with a peripheral length of e.g. 60 mm. At the same time, a high cut quality is achieved. The plasma jet is guided to the end position B at the return speed. During this process, the return speed of the plasma cutting torch is reduced in steps down to zero at point B, so that it is unnecessary to cut an additional lead-out path. The positions Al and B are identical here. By reducing the return speed and the associated deceleration of the plasma torch cutting machine, the lag of the plasma jet is reduced. Since the contour 503 was cut again in the opposite direction, any bridges remaining in the region of the counter-cut are cut and bevels are straightened.

Instead of guiding the plasma jet in the opposite direction to the cutting direction, alternatively a contour repeat can be provided such that, following the first contour, a second contour is cut in the same direction. Expanding on this, a further cut could be provided after the first contour cut, followed by a contour repeat in the cutting direction. This has advantages if process parameters are to be modified after the further cut, such as the cutting speed or the position or inclination of the plasma in relation to the workpiece surface.

FIGS. 7 and 8 show a third and fourth variant of the method according to the invention, which are both provided for cutting comparatively thick semi-finished product material thicknesses in the range of 50 mm to 100 mm.

The illustrations in FIGS. 7-I, 7-II and in 8-I, 8-II correspond to those of FIGS. 5-I and 5-II. Accordingly, reference is made to the description of the latter figures.

In the method variant according to FIG. 7, it is provided in FIG. 7-IIa that the contour cut 503 is continued along the line 710 as far as the point A2 after passing round the full circle once. This has the advantage that the plasma jet is positioned behind any micro-bridge remaining at the position A1.

When the point A2 is reached, the plasma cutting torch is positioned again because of the imminent change of direction. The plasma jet produced by the plasma cutting torch is then guided in the opposite direction to the cutting direction along the portion 711 of the contour 503 to the end position B at the return speed. The plasma cutting torch is switched off before it reaches the point B.

The method of FIG. 8 differs from the method according to FIG. 7 essentially by the fact that, in contrast to the portion 711, the portion 811 is in the form of a full circle, so that the entire contour is re-cut. The positions A2 and B are identical. This method is particularly suitable for small contours with a peripheral length of up to 60 mm. As a result, a high cut quality is achieved.

The methods described above all describe the cutting of inner contours. They can also, of course, be applied to the cutting of outer contours.

FIG. 9 shows a comparison between an outer contour (B) of a workpiece that was obtained using a cutting method according to the invention and an outer contour (A) of a workpiece as obtained with a conventional cutting method.

The most notable differences are highlighted by circles. The kerf in FIG. 9A is formed unevenly and in particular has cut surface damage on the underside of the workpiece.

The kerf from FIG. 9B, on the other hand, has an even, tapering shape.

In FIG. 10, an inner contour (B) of a workpiece obtained using a cutting method according to the invention according to FIG. 6 and an inner contour A, as obtained with a conventional cutting method, are compared. While the hole in FIG. 9A shows cutting damage in the lead-in region (left), an almost circular contour was obtained by the method according to the invention as in FIG. 6.

1. A method for the mechanical thermal cutting of a workpiece using
a plasma cutting torch, comprising the method steps of:
a) igniting a plasma jet,
b) producing a lead-in cut in a metallic, plate- or strip-type semi-finished product using the plasma jet,
c) cutting a contour into the semi-finished product by guiding the plasma jet along a predefined contour line at a cutting speed in a cutting direction,
wherein after cutting the contour according to step c), the plasma jet is guided in the opposite direction to the cutting direction along at least a portion of the cut contour at a return speed.

2. The method according to claim 1, wherein after cutting the contour according to step c), the plasma jet is guided in the opposite direction to the cutting direction along the entire cut contour.

3. The method according to claim 1, wherein the lead-in cut is cut at a lead-in cut speed, wherein the lead-in cut speed is increased while cutting the lead-in cut until the cutting speed is reached, wherein the return speed is in the range of 150% to 400% of the cutting speed.

4. The method according to claim 1, wherein while the plasma jet is being guided in the opposite direction to the cutting direction along at least a portion of the cut contour, the return speed is reduced continuously.

5. The method according to claim 1, wherein a contour is cut into a semi-finished product made of aluminium or steel with a material thickness in the range of 5 mm to 100 mm.

6. The method according claim 1, wherein after cutting the contour according to step c) and before guiding the plasma jet in the opposite direction to the cutting direction, a further cut takes place in the cutting direction.

7. The method according to claim 1, wherein when cutting the contour according to step c), the position of the plasma jet is shifted to the right or left in relation to the contour line, depending on the cutting direction.

8. The method according to claim 7, wherein when the plasma jet is being guided in the opposite direction to the cutting direction, the position of the plasma jet is shifted from left to right or from right to left as appropriate, relative to the contour line.

9. The method according to claim 5, wherein the semi-finished product is made of stainless steel.
